(19) United States
(12) Patent Application Publication
(10) Pub. No.: US 2025/0351187 A1
(43) Pub. Date: Nov. 13, 2025

(54) METHODS AND APPARATUSES FOR UPLINK SIGNAL ENHANCEMENT

(71) Applicant: LENOVO (BEIJING) LIMITED, Beijing (CN)

(72) Inventors: Jianfeng WANG, Beijing (CN); Tingnan BAO, Beijing (CN); Haiming WANG, Beijing (CN)

(21) Appl. No.: 18/867,197

(22) PCT Filed: May 20, 2022
(86) PCT No.: PCT/CN2022/094131

§ 371 Date: Nov. 19, 2024

(51) Int. Cl. H04W 74/0833; H04B 7/04; H04B 17/318; H04W 72/21

(52) U.S. Cl. CPC H04W 74/0833; H04B 7/04013; H04B 17/328; H04W 72/21

(57) ABSTRACT

Embodiments of the present application are related to methods and apparatuses of uplink signal enhancement. An embodiment of the present application provides a user equipment (UE) including: a wireless transceiver, and a processor coupled to the wireless transceiver, wherein the processor is configured to: transmit a signal, which is generated based on at least a re-configurable intelligent surface (RIS) identifier (ID), with the wireless transceiver; and transmit, with the wireless transceiver, a physical random access channel (PRACH) preamble after transmission of the signal.

### TECHNICAL FIELD

The present disclosure generally relates to wireless communications, and especially to uplink signal enhancement within a network.

### BACKGROUND OF THE INVENTION

In modern wireless communications, the propagation medium, i.e., radio, has been perceived as a randomly behaving entity between the transmitter and the receiver, which degrades the quality of the received signal due to the uncontrollable fading of the radio waves with the surrounding objects, and thus causes some communication failure, for example, initial random access (RA) failure for a user equipment (UE) especially for a UE in cell edge. If network operators can control the scattering, reflection, and refraction characteristics of the radio waves, by overcoming the negative effects of natural wireless propagation, the performance can be improved without the need for complex signal processing, radio frequency processing operations, and extra energy consumption.

Recently, many results, including both simulations and field tests, have revealed that the technology, termed re-configurable intelligent surface (RIS), can be used to control the scattering, reflection, and refraction characteristics of the radio waves, so as to enhance the signals transmitted from the UE and improve the network performance. The RIS is a planar meta-surface equipped with a large number of passive reflecting elements connected to a smart controller, which is capable of inducing an independent phase shift and/or amplitude attenuation (termed as “reflection coefficient”) to the incident signal at each reflecting element in real-time. In this way, it can modify the wireless channels between one or more pairs of transmitters and receivers and even the propagation environment to be more favorable for their communications.

### SUMMARY

The present disclosure provides various methods and apparatus regarding deploying an RIS in Radio access network (RAN) to enhance the uplink signals transmitted from an UE for example, during an initial RA procedure.

Some embodiments of the present disclosure provide a UE including: a processor and a wireless transceiver coupled to the processor, herein the processor is configured to, with the wireless transceiver: transmit a signal, which is generated based on at least an RIS identifier (ID), with the wireless transceiver; and transmit, with the wireless transceiver, a physical random access channel (PRACH) preamble after transmission of the signal.

In some embodiments of the present disclosure, the signal is a sequence generated with the RIS ID.

In some embodiments of the present disclosure, the sequence is one of m-sequence, ZC sequence, and Golden sequence.

In some embodiments of the present disclosure, a length of the sequence is associated with at least one of: transmission power of the signal; detection of the signal by an RIS associated with the RIS ID; or calculation of an AoA from the UE by the RIS.

In some embodiments of the present disclosure, the processor is further configured to: receive, with the wireless transceiver, a broadcast signal from a base station (BS) to obtain system information for initial RA procedure, wherein the system information includes the RIS ID; or receive, with the wireless transceiver, the RIS ID from the BS separate from the broadcast signal.

In some embodiments of the present disclosure, the processor is configured to: calculate reference signal received power (RSRP) from a BS, and transmission of the signal is in response to the calculated RSRP is less than a threshold.

In some embodiments of the present disclosure, the threshold is predefined or configured.

Some embodiments of the present disclosure provide an RIS including: a processor and a wireless transceiver coupled to the processor, herein the processor is configured to: receive, with the wireless transceiver and from a UE, a signal, which is generated based on at least a RIS ID; determine reflection coefficients based on at least the signal received from the UE; and reflect, with the wireless transceiver, a PRACH preamble from the UE to a BS according to at least the reflection coefficients.

In some embodiments of the present disclosure, the signal includes a sequence generated with the RIS ID.

In some embodiments of the present disclosure, the sequence is one of m-sequence, ZC sequence, Golden sequence.

In some embodiments of the present disclosure, a length of the sequence is associated with at least one of: transmission power of the signal; detection of the signal by the RIS; or calculation of an AoA from the UE by the RIS.

In some embodiments of the present disclosure, the processor is further configured to: calculate a first AoA associated with the signal received from the UE; and derive the reflection coefficients according to at least the first AoA.

In some embodiments of the present disclosure, the processor is further configured to: receive, with the wireless transceiver, system information from the BS to obtain a subframe configuration and an RA configuration; and calculate a second AoA from the BS, wherein the reflection coefficients are derived according to at least the first AoA and the second AoA.

Some embodiments of the present disclosure provide a BS including: a processor and a wireless transceiver coupled to the processor, herein the processor is configured to: transmit, with the wireless transceiver, an RIS ID to a UE; and receive, with the wireless transceiver, a PRACH preamble from the UE through an RIS associated with the RIS ID.

In some embodiments, the RIS ID is included in a broadcast signal of the BS or is separate from the broadcast signal of the BS.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary scenario according to some embodiments of the present disclosure.

FIG. 2 illustrates an exemplary probing signal according to some embodiments of the present disclosure.

FIG. 3 illustrates an exemplary method performed by a UE according to some embodiments of the present disclosure.

FIG. 4 illustrates an exemplary method performed by an RIS according to some embodiments of the present disclosure.

FIG. 5 illustrates an exemplary method performed by a BS according to some embodiments of the present disclosure.

FIG. 6 illustrates an exemplary procedure according to some embodiments of the present disclosure.

FIG. 7 illustrates a simplified block diagram of an exemplary apparatus according to some embodiments of the present disclosure.

FIG. 8 illustrates a simplified block diagram of an exemplary apparatus according to some embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In RAN, if a UE intends to access the network, it should launch the standardized initial RA procedure after receiving the relevant system information from a master information block (MIB) in physical broadcast channel (PBCH) and system information block (SIB) 1, such as cell ID, frame configuration, frame/time/frequency synchronization and RA configuration. For downlink, because of the ability of high transmission power and deployment of multiple antennas for high antenna and beamforming gain, the UEs in the cell edge can receive the broadcasted system information carrying the information above. However, on the other direction, i.e., for uplink, the transmission power, the number of antennas or the beamforming gain for a UE are limited, the BS or the network may fails to receive the signals transmitted from the UE, especially from the UE in the cell edge.

To guarantee the successful initial RA access from the UEs in the cell edge to the network, one way is to raising up the transmission power of the preamble (e.g., Msg.1) step on step once failed until success, reaching the maximum transmission power or the maximum number of attempts; however, it is not friendly for the power saving of the UEs and will cause interference in the wireless communications system.

Therefore, an RIS may be introduced to assist the (initial) RA requests from the UEs in the cell edge that expect to access the network; the RIS may reflect the signals transmitted from the UEs in cell edge to a BS, so as to control the scattering, reflection, and refraction characteristics of the radio waves and enhance the signals transmitted from the UE in the cell edge. The RIS may or may not locate in the cell edge.

However, when the UE is in the RRC_IDLE mode, neither the BS nor a legacy RIS knows when and how the UE will send the preamble for access before the UE initially access to the network. Therefore, it is impossible for a legacy RIS to generate the ideal reflection coefficients to reflect the preamble transmitted from the UE to the serving BS for the initial RA procedure.

The present disclosure provides a solution by introducing a probing signal (or referred as another name, as long as not violating the spirit of the present disclosure) for the (cell edge) UEs to enable an remote RIS equipment to configure the optimal reflection coefficients to enhance the signals transmitted from a UE for the initial RA procedure; based on the probing signal, an remote RIS can estimate the angle of arrival (AoA) of the initial access preamble from UEs, and generate the reflection coefficients of the RIS at least according to the AoA, so as to enhance the preambles transmitted from the UE for RA. The remote RIS equipment is configured and identified with an identification, i.e., RIS ID, in a serving cell, and the AoA of the PRACH preamble from a UE can be estimated via detecting the probing signal transmitted from the UE; thus, the remote RIS may generate the reflection coefficients of the RIS; based on the reflection coefficients, the signals transmitted from the UE may be reflected to a BS, and the BS may receive the signals correctly.

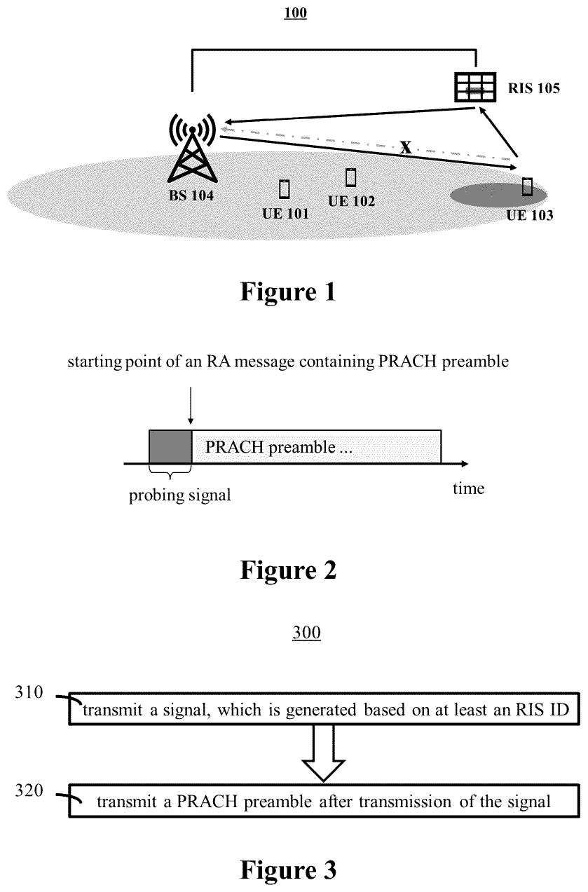

FIG. 1 illustrates an exemplary wireless communication system 100 according to some embodiments of the present disclosure.

Referring to FIG. 1, a wireless communications system 100 may include one or more UEs (e.g., UE 101, UE 102, UE 103), a BS 104, and a remote RIS 105. Although a specific number of the UEs, the BS(s), and the remote RIS(s) are depicted in FIG. 1, it is contemplated that any number of the UEs, the BSs and the remote RISs may be included in the wireless communications system 100. In this exemplary wireless communication system 100, the UE 103 is in the cell edge and is distant from the BS 104; it is contemplated that any number of UEs may be in the cell edge.

In some embodiments of the present disclosure, the UEs (e.g., UE 101, UE 102, and UE 103) may be devices in different forms or having different capabilities; in some cases, for example when the RSRP of a UE is under a threshold, said UE (e.g., the UE 103) may transmit the probing signal for an RIS (e.g., the RIS 105) to generate the reflection coefficients for enhancing the signals transmitted from the UE to a BS (e.g., BS 104). Specifically, as shown in FIG. 1, without the usage of the RIS 105, the signals transmitted from the UE 103 in the cell edge cannot be successfully received by the BS 104; or the signal quality of the uplink signals from the UE 103 is poor when arriving at the BS 104.

The UEs may include computing devices for generating the reflection coefficients. According to some embodiments of the present disclosure, each of the UEs in the wireless communications system 100, e.g., UE 101, UE 102, or UE 103 may be referred to as a portable wireless communication device, a smart phone, a cellular telephone, a flip phone, a device having a subscriber identity module, a personal computer, a selective call receiver, or any other device that is capable of transmitting and receiving information. In some embodiments, each of the UEs may include wearable devices, such as smart watches, fitness bands, optical head-mounted displays, or the like. Moreover, each of the UEs may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 104 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 104 is generally a part of a radio access network that may include a controller communicably coupled to the BS 104. In some embodiments of the present disclosure, the BS 104 may be dispersed throughout a geographic area to form the wireless communications system 100 and may be a device in different forms or having different capabilities. The information exchanges between the BS 104 and the UEs (e.g., UE 101, UE 102, or UE 103) in the wireless communications system 100 may include uplink (UL) transmissions from the UEs to the BSs (e.g., BS 104), or downlink (DL) transmissions from the BSs to the UEs over one or more carriers; some UL transmissions from the UEs may arrive at the BSs by the reflecting of the remote RISs. The BS 104 may broadcast the RIS ID of the RIS 105 in the serving cell.

The wireless communications system 100 may be compatible with any type of network that is capable of exchanging information between the BS 104 and the UEs (e.g., UE 101, UE 102, and UE 103). For example, the wireless communications system 100 is compatible with a cellular telephone network, a Time Division Multiple Access (TDMA)-based network, a Code Division Multiple Access (CDMA)-based network, an Orthogonal Frequency Division Multiple Access (OFDMA)-based network, a 3GPP-based network, a 3GPP LTE network, a 3GPP 5G NR network, a satellite communications network, a high altitude platform network, and/or other communications networks. More generally, however, the wireless communications system 100 may implement some other open or proprietary communication protocols, for example, IEEE 802.11 family, WiMAX, among other protocols.

In some embodiments of the present disclosure, the RIS 105 may receive the probing signal from a UE (e.g., UE 103), based on which it may calculates an AoA associated with the UE, and derive the reflection coefficients for the UE according to at least the AoA associated with the UE; in some embodiments, the RIS 105 may furthermore calculate an AoA associated with the BS 104. Based on at least one of the calculated AoAs, the RIS 105 may derive the reflection coefficients for the UE according to at least the AoA associated with the UE. The RIS 105 may reflect the PRACH preamble from the UE to the BS 104 according to at least the reflection coefficients; the PRACH preamble transmitted from the UE is enhanced and the success rate of the initial RA of the UE is improved.

According to some embodiments of the present disclosure, the probing signal used in the present disclosure is a sequence generated with the RIS ID of the remote RIS (e.g., the remote RIS 105) by the UE (e.g., UE 103).

In some embodiments, the probing signal (or the sequence) is one of m-sequence, ZC sequence, and Golden sequence.

In some embodiments, a length of the sequence is associated with at least one of:
transmission power of the signal;
detection of the signal by an RIS associated with the RIS ID; or.
calculation of an AoA from the UE by the RIS.

Specifically, the probing signal (or the sequence) should be long enough for a remote RIS to estimate the AoA from the UE; but it should not be too long to consume much transmission power; in other words, when deciding the sequence length, there should be some trade-off.

Furthermore, the transmission power of the probing signal should be great enough for a remote RIS to detect the probing signal; but it should not be too great to consume much transmission power; in other words, when deciding the transmission power of the signal, there should be some trade-off.

In some embodiments, the probing signal may be generated with the same waveform as that used for generating the uplink signal by the UE. For example, the probing signal may be an orthogonal frequency division multiplexing (OFDM) based signal, or sensing signal for an integrated sensing communication (ISAC) system, or frequency-modulated continuous wave (FMCW) signal.

The probing signal is transmitted before transmitting a PRACH preamble (or an RA message for RA procedure which contains the PRACH preamble, e.g., Msg 1) in an RA procedure. In some embodiments, the probing signal is attached in front of the PRACH preamble.

FIG. 2 illustrates an exemplary probing signal 200 according to some embodiments of the present disclosure; wherein the probing signal is attached in front of the RA message containing the PRACH preamble. In some embodiments, the probing signal and the PRACH preamble (or the RA message) will be transmitted together. In some another embodiments, there may be a gap between the probing signal and the PRACH preamble (or the RA message). In some yet another embodiments, the probing signal and the PRACH preamble will be transmitted in independent signalings.

FIG. 3 illustrates an exemplary method 300 performed by a UE (e.g., UE 103) according to some embodiments of the present disclosure. As illustrated in FIG. 3, method 300 includes operation 310 and operation 320.

In some embodiments, in operation 310, the UE generates a signal, e.g., the probing signal, based on at least an RIS ID and transmits the generated signal for facilitating initial RA procedure. In some embodiments, the UE receives a broadcast signal from the BS (e.g., BS 104), wherein the broadcast signal include system information for initial RA procedure in the serving cell, and the system information includes the RIS ID of the remote RIS. In some embodiments, the UE receives the RIS ID of the remote RIS separating from the broadcast signal including the system information. The system information may include at least the frame pattern, i.e., uplink/downlink subframe configuration and the RA configuration. When the UE receives the system information, the UE may perform downlink synchronization and receive the broadcast signal to obtain the basic system information; furthermore, the UE may calculate corresponding RSRP.

In some embodiments, in operation 320, the UE transmits a PRACH preamble after transmission of the probing signal.

In some embodiments, in the case that the calculated RSRP corresponding to the received (basic) system information is less than a threshold, the UE performs method 300 for initial RA and transmits the probing signal: the threshold is predefined or configured.

According to some embodiments of the present disclosure, as long as it calculates RSRP from the BS and the calculated RSRP is less than the threshold, the UE may perform method 300 including transmitting a probing signal to an RIS for enhancing its uplink signals to the BS. For example, if UE 101 which is not in the cell edge determines that the calculated RSRP corresponding to the received (basic) system information is less than the threshold due to some reason, it may perform method 300 for initial RA, including transmitting a probing signal to an RIS for enhancing its uplink signals to the BS. In some embodiments, a UE may perform method 300 for initial RA if it is located in a specific area, such as the peripheral of the coverage of a service cell or a blind zone with poor signal quality.

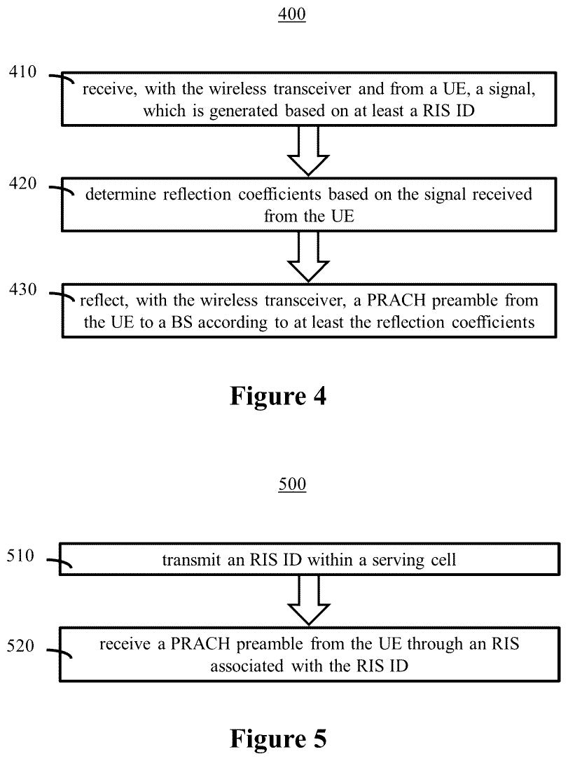

FIG. 4 illustrates an exemplary method 400 performed by an RIS (e.g., RIS 105) according to some embodiments of the present disclosure, the RIS is configured or preconfigured to be associated with an RIS ID. As illustrated in FIG. 4, method 400 includes operation 410, operation 420, and operation 430.

In some embodiments, in operation 410, the RIS receives from a UE (e.g., UE 103), a signal (e.g., the probing signal) generated based on at least an RIS ID associated with the RIS by the UE.

In some embodiments, in operation 420, the RIS determines reflection coefficients associated with the UE based on the signal received from the UE; the RIS calculates an AoA associated with the signal received from the UE, and derives or determines the reflection coefficients based on the calculated AoA from the UE.

In some embodiments, in operation 420, the RIS receives a broadcast signal from the BS (e.g., BS 104), wherein the broadcast signal include system information for initial RA procedure in the serving cell; the system information may include at least the frame pattern, i.e., uplink/downlink subframe configuration and the RA configuration. When the RIS receives the system information, it may perform downlink synchronization and receive the broadcast signal to obtain the basic system information including at least a subframe configuration and a RA configuration; the RIS further calculates a corresponding AoA from the BS; the reflection coefficients associated with the UE (e.g., the UE 103) are derived according to at least the AoA from the UE and the AoA from the BS.

In some embodiments, in operation 430, the RIS reflects the PRACH preamble from the UE (e.g., the UE 103) to the BS (e.g., the BS 104) according to at least the determined reflection coefficients.

In some embodiments, the RIS is one of the at least one RIS within the serving cell that is closed to the UE (e.g., the UE 103) from which the RIS receives the probing signal.

FIG. 5 illustrates an exemplary method 500 performed by a BS (e.g., BS 104) according to some embodiments of the present disclosure. As illustrated in FIG. 5, method 500 includes operation 510 and operation 520.

In some embodiments, in operation 510, the BS transmits at least one RIS ID within a serving cell, a UE (e.g., the UE 101, UE 102, UE 103) may receive the at least one RIS ID, each RIS ID is associated with an RIS (e.g., the RIS 105). In some embodiments, the RIS ID is included in a broadcast signal transmitted from the BS or is separate from the broadcast signal.

In some embodiments, in operation 520, the BS receives a PRACH preamble from the UE through an RIS (e.g., the RIS 105) associated with the RIS ID.

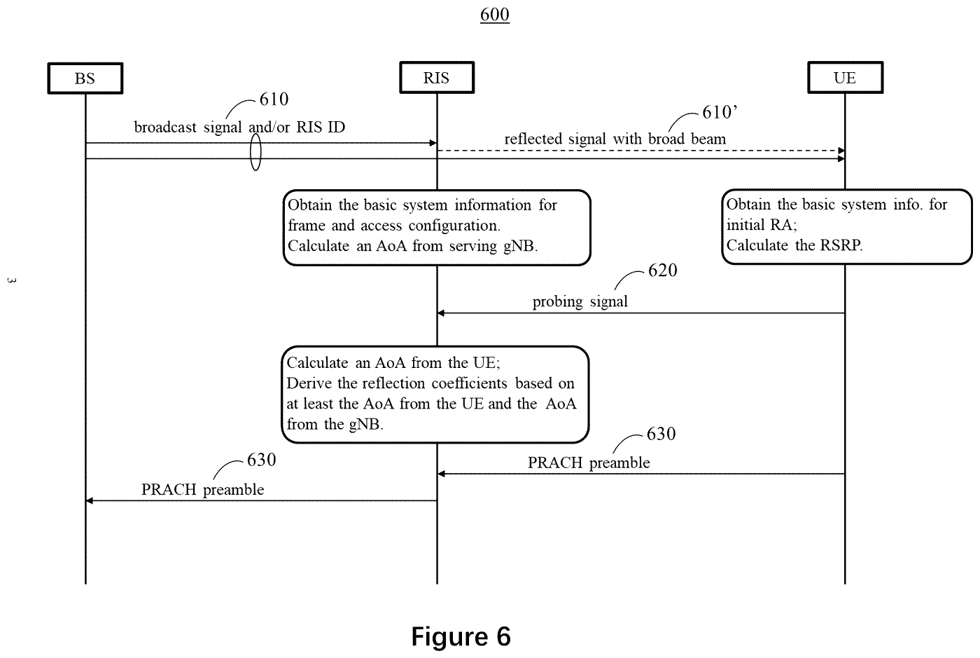

FIG. 6 illustrates an exemplary procedure 600 of switching waveform according to some embodiments of the present disclosure. It is contemplated the present disclosure is not limited to this exemplary procedure 600. In this example, the RIS is an RIS within the serving cell that is closed to the UE.

In this exemplary procedure, the BS (e.g., the BS 104) broadcasts the signal 610 in the serving cell. In some embodiments, the signal 610 includes a broadcast signal including system information for initial RA procedure, and the system information includes at least one RIS ID associated with at least one RIS (e.g., RIS 105) within a serving cell. In some embodiments, the signal 610 includes a broadcast signal and at least one RIS ID associated with at least one RIS (e.g., RIS 105). The UE (e.g., the UE 101, UE 102, or UE 103) and the RIS (e.g., the RIS 105) receives the signal 610. In some embodiments, the RIS may reflect the received signal 610 to the UE; i.e., the RIS may transmit reflected signal 610′ of the signal 610 to the UE; before the RIS receives a probing signal from the UE, the reflection coefficients for the UE may be not optimal or suitable reflection coefficients.

Based on the received signal 610 and/or the received signal 610′, the UE obtains system information for initial RA procedure and the RIS ID associated with the RIS 105. Furthermore, the UE calculates a corresponding RSRP: if the RSRP is not less than a threshold, the UE will not transmit a probing signal; otherwise, the UE will transmit a probing signal to the RIS (e.g., the RIS 105). In this example, the calculated RSRP is less than the threshold, and the UE transmits a probing signal 620 to the RIS; it is contemplated that the UE may be a UE in the cell edge or a UE not being in the cell edge but the associated RSRP being less than a threshold.

The RIS receives the probing signal 620 and calculate an AoA associated with the UE based on at least the probing signal 620.

Furthermore, based on the received signal 610, the RIS obtains system information for initial RA procedure to acquire a subframe configuration and an RA configuration, and calculates an AoA from the serving gNB according to at least the signal 610.

Then the RIS derives or determines the reflection coefficients associated with the UE according to at least the AoA from the UE and the AoA from the gNB.

The UE transmits a PRACH preamble 630 to the RIS after the transmission of the probing signal 620. In some embodiments, the PRACH preamble 630 or the message for RA procedure containing the PRACH preamble 630 is attached at the end of the probing signal 620. In this example, the UE may also transmit the PRACH preamble 630 to the BS, but as it is in the cell edge, the signal quality of the PRACH preamble 630 when arriving at the BS is poor, and the BS may fails to receive the PRACH preamble 630.

The RIS reflects the PRACH preamble 630 from the UE to the BS according to at least the derived or calculated reflection coefficients associated with the UE.

In the later operations, the RIS may reflect the signals transmitted from the BS to the UE (e.g., Msg 2) and reflect the signals transmitted from the UE to the BS during e.g., the initial RA procedure.

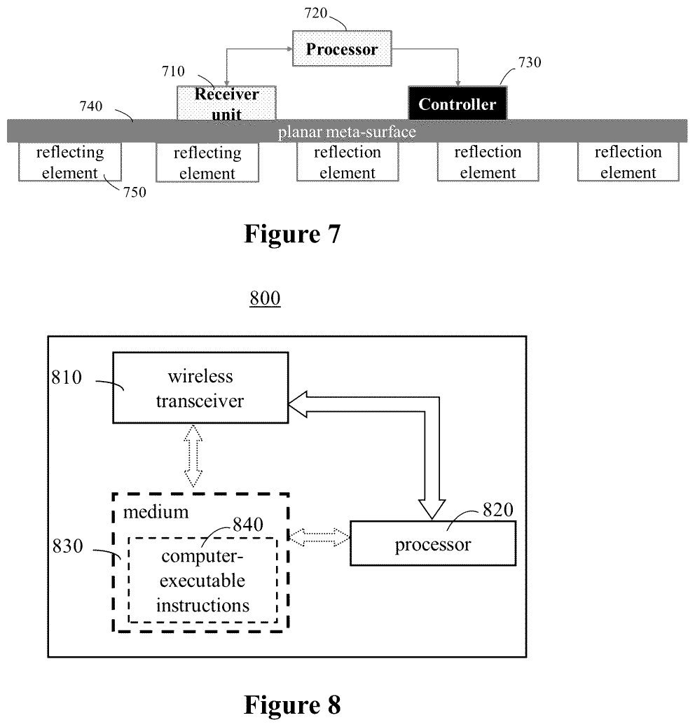

FIG. 7 illustrates a simplified block diagram of an exemplary apparatus 700 according to various embodiments of the present disclosure. In some embodiments, apparatus 700 may be or include at least a part of an RIS (e.g., RIS 105) or similar device that can use the technology of the present disclosure. The apparatus 700 may at least perform any method (e.g., method 400) described above which is performed by an RIS according to the present disclosure.

As shown in FIG. 7, the apparatus 700 includes an receiver unit 710, a processor 720, a planar meta-surface 740 equipped with a plurality of passive reflecting elements 750 connected to a controller 730, which is capable of inducing reflection coefficient to the incident signal at each reflecting element 750 in real-time. In some embodiments, some transmission unit can be optionally attached. It is contemplated that an RIS according to the present disclosure is not limited to apparatus 700. Furthermore, it is contemplated that an RIS according to the present disclosure may include at least one medium for storing some parameters (e.g., the reflection coefficients associated with the UE, and an RIS ID associated with the RIS), instructions, or etc.

The receiver unit 710 includes the basic receiving chain or sensing signal receiving chain for the expected radio signals. The receiver unit 710 can also receive signals carrying the system information in RAN to acquire the system information, including at least the downlink synchronization signals, system configurations on the radio frame pattern and RA.

The processor (or the digital signal processor) 720 is a centre processor unit, it can decode the signals carrying the system information explained above. In addition, it can calculate an AoA associated with the UE based on at least a received probing signal from the UE; it can also calculate an AoA associated with the BS based on at least the received downlink signals from the BS. Based on the two AoAs, the processor 720 may calculate or derive the optimal reflect coefficients associated with the UE.

The controller 730 may control the reflection coefficients of all reflection elements 750, according to the indications (including at least the derived reflection coefficients associated with the UE) from the processor 720, so as to modify the wireless channels between one or more pairs of transmitters and receivers and even make the propagation environment to be more favourable for their communications. In some embodiments, the processor 720 and the controller 730 can integrated as one computing device.

FIG. 8 illustrates a simplified block diagram of an exemplary apparatus 800 according to various embodiments of the present disclosure.

In some embodiments, apparatus 800 may be or include at least a part of a UE (e.g., UE 101, UE 102, and UE 103) or similar device that can use the technology of the present disclosure.

In some embodiments, apparatus 800 may be or include at least a part of a BS (e.g., BS 104) or similar device that can use the technology of the present disclosure.

As shown in FIG. 8, apparatus 800 may include at least wireless transceiver 810 and processor 820, wherein wireless transceiver 810 may be coupled to processor 820. Furthermore, apparatus 800 may include non-transitory computer-readable medium 830 with computer-executable instructions 840 stored thereon, wherein non-transitory computer-readable medium 830 may be coupled to processor 820, and computer-executable instructions 840 may be configured to be executable by processor 820. In some embodiments, wireless transceiver 810, non-transitory computer-readable medium 830, and processor 820 may be coupled to each other via one or more local buses.

Although in FIG. 8, elements such as wireless transceiver 810, non-transitory computer-readable medium 830, and processor 820 are described in the singular, the plural is contemplated unless limitation to the singular is explicitly stated. In certain embodiments of the present disclosure, the apparatus 800 may further include other components for actual usage.

In some embodiments, the apparatus 800 is a UE or at least a part of a UE. Processor 820 is configured to cause the apparatus 800 at least to perform, with wireless transceiver 810, any method (e.g., method 300) described above which is performed by a UE according to the present disclosure.

In some embodiments, the apparatus 800 is a BS or at least a part of a BS. Processor 820 is configured to cause the apparatus 800 at least to perform, with wireless transceiver 810, any method (e.g., method 500) described above which is performed by a BS according to the present disclosure.

In various example embodiments, processor 820 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 820 may also include at least one other circuitry or element not shown in FIG. 8.

In various example embodiments, non-transitory computer-readable medium 830 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 830 may include, but is not limited to, an electric, a magnetic, an optical, an electromagnetic, an infrared, or a semiconductor system, apparatus, or device or any combination of the above.

Further, in various example embodiments, exemplary apparatus 800 may also include at least one other circuitry, element, and interface, for example antenna element, and the like.

In various example embodiments, the circuitries, parts, elements, and interfaces in exemplary apparatus 800, including processor 820 and non-transitory computer-readable medium 830, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
transmit a signal that is generated based on at least a re-configurable intelligent surface (RIS) identifier (ID); and
transmit a physical random access channel (PRACH) preamble after transmission of the signal.

2. The UE of claim 1, wherein the signal is a sequence generated with the RIS ID.

3. The UE of claim 2, wherein the sequence is one of an m-sequence, a ZC sequence, and a Golden sequence.

4. The UE of claim 2, wherein a length of the sequence is associated with at least one of:
transmission power of the signal;
detection of the signal by an RIS associated with the RIS ID; or
calculation of an angle of arrival (AoA) from the UE by the RIS.

5. The UE of claim 1, wherein the at least one processor is further configured to cause the UE to:
receive a broadcast signal from a base station (BS) to obtain system information for an initial random access (RA) procedure, wherein the system information includes the RIS ID; or
receive the RIS ID from the BS separate from the broadcast signal.

6. The UE of claim 1, wherein the at least one processor is further configured to cause the UE to:
calculate a reference signal received power (RSRP) from a base station (BS), wherein transmission of the signal is in response to the calculated RSRP is being less than a threshold.

7. The UE of claim 6, wherein the threshold is predefined or configured.

8. A re-configurable intelligent surface (RIS) for wireless communication, comprising:
at least one memory; and
at least one processor coupled with the at least one memory and configured to cause the RIS to:
receive, from a user equipment (UE), a signal that is generated based on at least a re-configurable intelligent surface (RIS) identifier (ID);
determine reflection coefficients based on at least the signal received from the UE; and
reflect a physical random access channel (PRACH) preamble from the UE to a base station (BS) at least based on the reflection coefficients.

9. The RIS of claim 8, wherein the signal includes a sequence generated with the RIS ID.

10. The RIS of claim 9, wherein the sequence is one of an m-sequence, a ZC sequence, and a Golden sequence.

11. The RIS of claim 9, wherein a length of the sequence is associated with at least one of:
transmission power of the signal;
detection of the signal by the RIS; or
calculation of an angle of arrival (AoA) from the UE by the RIS.

12. The RIS of claim 8, wherein the at least one processor is further configured to cause the RIS to:
calculate a first AoA associated with the signal received from the UE; and
derive the reflection coefficients according to at least the first AoA.

13. The RIS of claim 12, wherein the at least one processor is further configured to cause the RIS to:
receive system information from the BS to obtain a subframe configuration and an RA configuration; and
calculate a second AoA from the BS, wherein
the reflection coefficients are derived according to at least the first AoA and the second AoA.

14. A base station (BS) for wireless communication, comprising:
at least one memory; and
at least one processor coupled with the at least one memory and configured to cause the BS to:
transmit a re-configurable intelligent surface (RIS) identifier (ID) to a user equipment (UE); and
receive a physical random access channel (PRACH) preamble from the UE through an RIS associated with the RIS ID.

15. The BS of claim 14, wherein the RIS ID is included in a broadcast signal of the BS or is separate from the broadcast signal of the BS.

16. A processor for wireless communication, comprising:
at least one controller coupled with at least one memory and configured to cause the processor to:
transmit a signal that is generated based on at least a re-configurable intelligent surface (RIS) identifier (ID); and
transmit a physical random access channel (PRACH) preamble after transmission of the signal.

17. The processor of claim 16, wherein the signal is a sequence generated with the RIS ID.

18. The processor of claim 17, wherein the sequence is one of an m-sequence, a ZC sequence, and a Golden sequence.

19. The processor of claim 17, wherein a length of the sequence is associated with at least one of:
transmission power of the signal;
detection of the signal by an RIS associated with the RIS ID; or
calculation of an angle of arrival (AoA) from the processor by the RIS.

20. The processor of claim 16, wherein the at least one controller is further configured to cause the processor to:
receive a broadcast signal from a base station (BS) to obtain system information for an initial random access (RA) procedure, wherein the system information includes the RIS ID; or
receive the RIS ID from the BS separate from the broadcast signal.
